(19) United States
(12) Patent Application Publication
(10) Pub. No.: US 2006/0071897 A1
(43) Pub. Date: Apr. 6, 2006

(54) Liquid crystal display and method for driving thereof

(76) Inventor: Seung-Hwan Moon, Seoul (KR)

Correspondence Address: DLA PIPER RUDNICK GRAY CARY US, LLP, 2000 UNIVERSITY AVENUE, E. PALO ALTO, CA, 94303-2248, US

(21) Appl. No.: 10/509,201

(22) PCT Filed: Apr. 28, 2003
(86) PCT No.: PCT/KR03/00860

§ 371 Date: Jun. 30, 2005

(30) Foreign Application Priority Data
May 3, 2002 (KR) 10-2002-0024399

(51) Int. Cl. G09G 3/36

(52) U.S. Cl. 345/98; 345/204

(57) ABSTRACT

The present invention relates to a liquid crystal display and a driving method thereof. A liquid crystal display according to the present invention comprises: a liquid crystal panel assembly including a plurality of gate lines, a plurality of data lines which are insulated from and intersects the gate lines, and a plurality of pixels each of which is formed in an area defined by the data line and the gate line and has a switching element connected to the gate line and the data line; a gate driver for supplying gate voltages to the gate lines; at least one data driver for supplying data voltages corresponding to image data to the data lines; and a timing controller for comparing nth image data applied from outside and (n−1)th image data stored therein and selectively providing the nth image data to the data driver depending on the comparison result. According to the present invention, since image data transmission between the timing controller and the data driver can be minimized, power consumption and EMI due to image data switching can be reduced.

### BACKGROUND OF THE INVENTION

(a) Field of the Invention

The present invention relates to a liquid crystal display and a driving method thereof.

(b) Description of Related Art

Recently, it is required for display devices to become lighter and thinner, as personal computers and televisions become lighter and thinner. To meet these requirements, flat panel displays such as a liquid crystal display (LCD) has been developing instead of a cathode ray tube (CRT).

An LCD is a display device that obtains intended image signal by applying electric field to liquid crystal material having dielectric anisotropy, which is interposed between two panels, and controlling the intensity of the electric field to adjust the transmittance of light passing through the panels. The LCD is a representative one among portable flat panel displays (FPDs), and the most popular one among those LCDs is a TFT-LCD using thin film transistors (TFTs) as switching elements.

A conventional LCD includes a plurality of gate lines transmitting scan signals, a plurality of data lines intersecting the gate lines and transmitting image data, and a plurality of pixels formed in areas defined by the gate lines and the data lines in a matrix and connected to the gate lines and the data lines via respective switching elements.

To apply image data to each pixel of an LCD, gate on signals, which are scanning signals, are sequentially applied to the gate lines to turn on the switching elements connected thereto, and image data (more specifically, gray voltages) to be applied to a pixel line corresponding to the gate line are provided for each data line simultaneously. Then, image data provided to the data line are applied to the pixels via the switching elements turned on. If image data are applied to all pixel rows by sequentially applying gate on signals to all gate lines during one (1) frame period, an image of a frame can be displayed.

A timing controller that controls overall operation of an LCD transmits the image data to a data driver IC, and the data driver IC applies the received image data to the pixels as described above.

On the other hand, frequency of image data gets larger as the resolution of an LCD becomes higher. Since a PCB (printed circuit board) cannot deal with the increased frequency, the number of buses that transmit image data from the timing controller to the data driver IC should be increased. Then, EMI (electro magnetic interference) of an LCD increases as well as power consumption. Therefore, the transmission method of image data from the timing controller to the driver IC becomes more important.

Since the timing controller of an LCD transforms the image data to 8-bit binary codes and transmits them to the driving IC via data bus, code transition between the current data and the next data is frequently generated, which increases power consumption.

That is, since power consumption during data transmission can be expressed as P=cV²f (where c is a capacitance of a PCB, V is a swing width of voltage, and f is a frequency of image data transition), power consumption increases as data transition occurs more frequently during data transmission.

### SUMMARY OF THE INVENTION

Therefore, the present invention is directed to reduce power consumption during image data transmission of an LCD.

According to a first aspect of the present invention, an LCD including a liquid crystal panel assembly, a gate driver, at least one data driver, and a timing controller is provided. The liquid crystal panel assembly includes a plurality of gate lines, a plurality of data lines which are insulated from and intersects the gate lines, and a plurality of pixels each of which is formed in an area defined by the data line and the gate line and has a switching element connected to the gate line and the data line. The gate driver supplies gate voltages to the gate lines, and the data drivers supply data voltages corresponding to image data to the data lines. The timing controller compares nth image data applied from outside and (n−1)th image data stored therein and selectively provides the nth image data to the data driver depending on the comparison result

The timing controller generates an operation control signal based on the comparison result and provides the operation control signal to the data driver, and the data driver is operated with a mode, based on the operation control signal, selected from a holding mode which provides data voltages corresponding to the stored (n−1)th image data, an inverting mode which provides data voltages corresponding to the inverted (n−1)th image data, and an updating mode which provides data voltages corresponding to the nth image data provided from the timing controller.

The timing controller includes a first line memory for storing the nth image data applied from outside; a second line memory in which the (n−1)th image data applied in advance are stored; and a control signal generator for generating an operation control signal after comparing the nth image data and the (n−1)th image data.

The control signal generator generates: an operation control signal of a first status to let the data driver operate with the holding mode when all bits of the nth image data and the (n−1)th image data are equal to each other; an operation control signal of a second status to let the data driver operate with the inverting mode when all bits of the nth image data and the (n−1)th image data are complementary to each other; and an operation control signal of a third status to let the data driver operate with the updating mode when at least one bit of the nth image data and at least one corresponding bit of the (n−1)th image data are not equal or complementary to each other.

It is preferable that the timing controller does not provide the nth image data to the data driver when all bits of the nth image data and the (n−1)th image data are equal or complementary to each other.

The timing controller generates an operation control signal whose status changes by 1H period by comparing the nth image data and the (n−1)th image data during 1H period; and the data driver holds, inverts, or updates the image data by 1H period.

Alternatively, the timing controller generates an operation control signal whose status changes as many times as the number of the data drivers by 1H period by comparing the nth image data and the (n−1)th image data for each data driver during 1H period; and the data driver holds, inverts, or updates the image data for each data driver.

Alternatively, the timing controller generates an operation control signal whose status changes as many times as the number of pixels of a line by 1H period by comparing the nth image data and the (n−1)th image data for each pixel during 1H period; and the data driver holds, inverts, or updates the image data for each pixel.

The operation control signal may be a 2-bit signal; and the data driver includes: an exclusive logical sum operator for performing an exclusive logical sum operation based on a first bit of the operation control signal; a first multiplexer for selecting one, based on the second bit of the operation control signal, from a first input which is a signal provided from the exclusive logical sum operator and a second input which is image data provided from the timing controller, and outputting the selected signal; a D flip-flop for outputting image data provided selectively from the first multiplexer according to a signal applied to a clock terminal; and a logical multiplication operator for a logical multiplication operation of the applied data clock signal and a Carry signal and providing the result to the clock terminal of the D flip-flop. The data clock signal can be applied when at least one bit of the nth image data and at least one corresponding bit of the (n−1)th image data are not equal or complementary to each other.

According to another aspect of the present invention, a driving method of an LCD including the steps of: a) providing data voltages according to image data to the data line; and b) making the data voltage be applied to the pixel by providing a gate voltage to the gate line is provided. The LCD includes a plurality of gate lines, a plurality of data lines which are insulated from and intersects the gate lines, and a plurality of pixels each of which is formed in an area defined by the data line and the gate line and has a switching element connected to the gate line and the data line.

The a) step includes the steps of: comparing (n−1)th image data provided in advance and nth image data being provided currently; providing data voltages corresponding to the (n−1)th image data to the data line when all bits of the nth image data and the (n−1)th image data are equal to each other; inverting the (n−1)th image data and providing data voltages corresponding thereto when all bits of the nth image data and the (n−1)th image data are complementary to each other; and providing data voltages corresponding to the nth image data to the data line when at least one bit of the nth image data and at least one corresponding bit of the (n−1)th image data are not equal or complementary to each other.

The a) step compares the nth image data and the (n−1)th image data during 1H period. Alternatively, the a) step compares the nth image data and the (n−1)th image data for each data driver of the liquid crystal display during 1H period. The a) step may compare the nth image data and the (n−1)th image data for each pixel during 1H period.

### BRIEF DESCRIPTION OF THE DRAWINGS

The above and other advantages of the present invention will become more apparent by describing preferred embodiments thereof in detail with reference to the accompanying drawings in which:

FIG. 1 is a schematic layout diagram of an LCD according to an embodiment of the present invention;

FIG. 2 is a schematic diagram of a timing controller according to an embodiment of the present invention;

FIG. 3 is a schematic diagram of an LCD according to another embodiment of the present invention;

FIG. 4 is a schematic diagram of a data driver according to a first example of the present invention; and

FIG. 5 is a schematic diagram of a data driver according to a second example of the present invention.

### DETAILED DESCRIPTION OF THE PREFERRED EMBODIMENTS

The present invention now will be described more fully hereinafter with reference to the accompanying drawings, in which preferred embodiments of the inventions invention are shown. The present invention may, however, be embodied in many different forms and should not be construed as limited to the embodiments set forth herein.

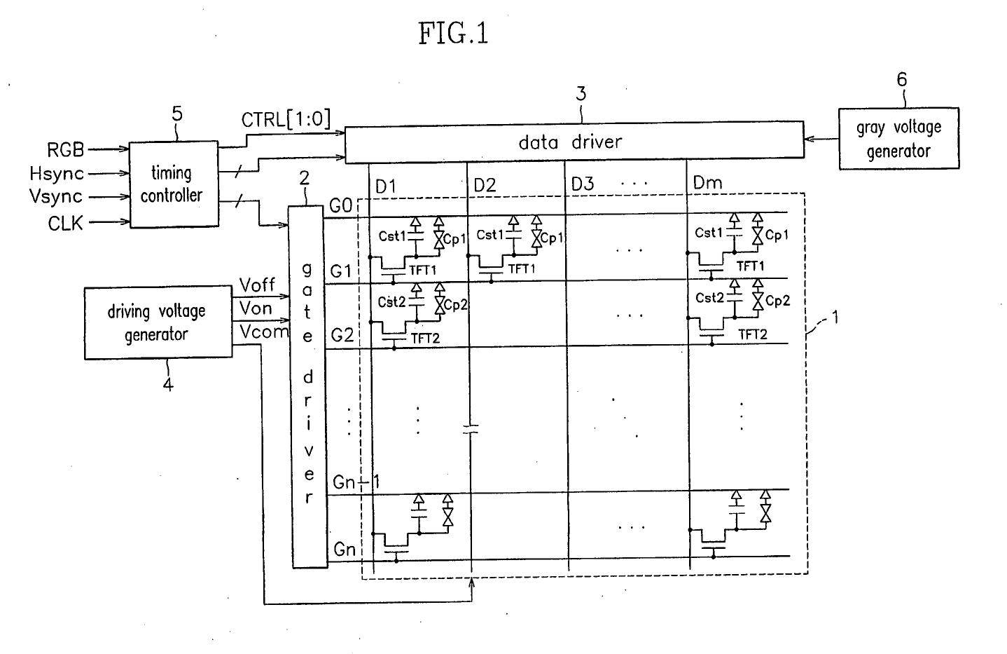

In the drawings, the thickness of layers and regions are exaggerated for clarity. Like numerals refer to like elements throughout. It will be understood that when an element such as a layer, region or substrate is referred to as being “on” another element, it can be directly on the other element or intervening elements may also be present. In contrast, when an element is referred to as being “directly on” another element, there are no intervening elements present FIG. 1 is a schematic layout diagram of an LCD according to an embodiment of the present invention.

Referring to FIG. 1, an LCD according to an embodiment of the present invention includes a liquid crystal panel assembly 1, a gate driver 2, a data driver 3, a driving voltage generator 4, a timing controller 5, and a gray voltage generator 6.

The liquid crystal panel assembly 1 includes two panels (for example, a TFT array panel and a color filter panel). A plurality of gate lines and a plurality of data lines, which intersect each other, are formed on one of the two panels, and a plurality of pixels are provided in areas defined by the gate lines and the data lines, each of which includes a TFT which is a switching element whose gate electrode, source electrode, and drain electrode are connected to the gate line, the data line, and a pixel electrode, respectively.

The timing controller 5 receives R (red), G (green), and B (blue) data signals, a vertical synchronization signal Vsync which is a frame distinction signal, a horizontal synchronization signal Hsync which is a row distinction signal, and a main clock signal CLK from a graphic controller (not shown) outside of an LCD module, and outputs digital signals for driving the gate driver 2 and the data driver 3.

Timing signals that the tuning controller 5 outputs to the gate driver 2 include a vertical start signal Vstart for commanding a start of application of a gate ON voltage to apply the gate On voltage to the gate line, a gate clock signal (hereinafter “CPV” signal) for sequentially applying the gate On voltage to each gate line, and a gate On enable signal OE for enabling an output of the gate driver 2.

Timing signals that the timing controller 5 outputs to the data driver 3 include a horizontal start signal Hstart for commanding an input of digital data signals [R(0:N), G(0:N), B(0:N)] received from the graphic controller to the data driver 3, a signal for commanding an application of the data signals, which are transformed to analog signals in the data driver 3, to the panel (hereinafter “LOAD” signal), and a horizontal clock signal HCLK for a data shift in the data driver 3.

According to an embodiment of the present invention, an operation control signal CTRL is generated and provided to the data driver 3 to let the data driver 3 hold, invert, or update the inputted image data.

For example, the operation control signal CTRL may have values as listed on Table 1.

TABLE 1

| CRTL | [1:0] | Operational mode |
|---|---|---|
| CRTL[1] | CTRL[0] | |
| 0 | 0 | Hold |
| 0 | 1 | Invert |
| 1 | x | Update |

The data driver 3 is also called as the source driver, and it performs a role of applying voltages to each pixel of the liquid crystal panel assembly 1 by line. More specifically, the data driver 3 stores digital data received from the timing controller 5 in a shift register inside the data driver 3, selects voltages corresponding to each one of the data when a LOAD signal is received, and transfers the selected voltages to the liquid crystal panel assembly 1. According to an embodiment of the present invention, the data driver 3 determines which image data are provided from the timing controller 5 based on'the operation control signal CTRL[1:0] received from the tiring controller 5, performs a designated operation on the image data based on the determination result, and transmits the image data to the liquid crystal panel assembly 1.

According to Table 1, in case that the operation control signal is ‘00’ (CTRL[1:0]=‘00’), the data driver 3 ignores an image data input from the timing controller 5, and provides the image data stored in the shift register instead to the liquid crystal panel assembly 1 according to a LOAD signal. In case that the operation control signal is ‘01’ (CTRL[1:0]=‘01’), the data driver 3 ignores an image data input from the timing controller 5, inverts the image data stored in the shift register, and provides the inverted image data to the liquid crystal panel assembly 1 instead of the image data as those are. On the other hand, in case that the operation control signal is ‘1x’ (CTRL[1:0]=‘01’), the data driver 3 receives image data from the timing controller 5, stores them in the shift register, and provides the image data to the liquid crystal panel assembly 1 according to a LOAD signal.

The gate driver 2 is also called as the scan driver, and it performs a role of opening a path for data from the data driver 3 to be transmitted to a pixel. Each pixel of the liquid crystal panel assembly 1 is turned on/off by a TFT, which serves as a switch, and the on/off operation of the TFT is performed by applying a prescribed voltage Von or Voff to the gate. The gate driver 2 receives CPV signal and OE signal outputted from the timing controller 5 and applies gate ON voltages G1, G2, . . . , Gn sequentially to the gate lines synchronized with the two signals CPV and OE.

The gray voltage generator 6 generates gray voltages divided by the number of bit of RGB data provided from the graphic controller (not shown) and provides them to the data driver 3. The data driver 3 is driven by the signals outputted from the timing controller 5 to apply the data voltages D1, D2, . . . , Dm to all the data lines synchronized with driving of the gate driver 2. Assuming that the data voltages D1, D2, . . . , Dm are not influenced very much by delays of the data is lines, they are charged to corresponding pixels during the interval synchronized with a high interval of the gate ON voltages G1, G2, . . . , Gn.

On the other hand, a Von voltage for turning on the gate of the TFT and a Voff voltage for turning off the gate of the TFT are generated on the driving voltage generator 4. The driving voltage generator 4 generates a Vcom voltage, which is a reference of the data voltage difference in the pixel, as well as the Von and Voff voltages, and Vcom voltage is provided to a common electrode of each pixel.

According to an embodiment of the present invention, the timing controller of an LCD compares image data of a nth line provided from an external graphic controller (not shown) (hereinafter “nth image data”) and image data of a (n−1)th line provided in advance (hereinafter “(n−1)th image data”) and outputs an operation control signal to the data driver without outputting the image data themselves when the two image data are equal or complementary to each other to let the data driver provide data voltages to the liquid crystal panel assembly based on the (n−1)th image data received in advance. When the two image data are neither equal nor complementary to each other, the timing controller outputs an operation control signal together with the nth image data, and the data driver provides data voltages corresponding to the nth image data to the liquid crystal panel assembly.

If the timing controller selectively provides image data depending on the relationship between the nth image data and the (n−1)th image data, power consumption for image data transmission can be reduced.

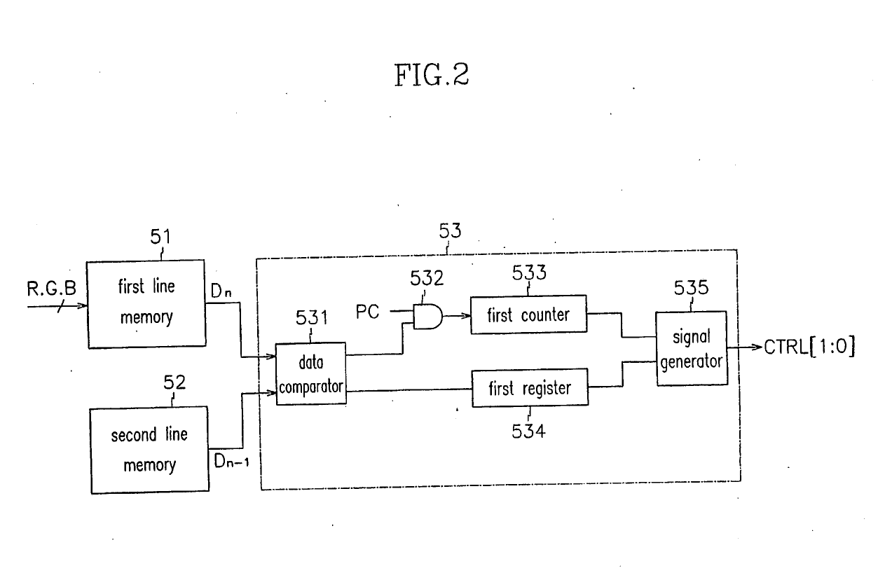

FIG. 2 is a schematic diagram of a timing controller for comparing image data.

Referring to FIG. 2, a timing controller according to an embodiment of the present invention includes a first line memory 51 for storing the nth image data Dn applied from outside, a second line memory 52 in which the (n−1)th image data Dn−1, which are applied in advance, are stored, and a control signal generator 53 for comparing the nth image data and the (n−1)th image data and generating an operation control signal.

The control signal generator 53 includes a data comparator 531 for comparing the nth image data and the (n−1)th image data and outputting a first signal and a second signal each of which having a value “0” or “1” as a result of comparison, a logical multiplication (AND) operator 532 for logical multiplication operation on the first signal outputted from the data comparator 531 and a pixel clock signal PC applied thereto to output a counting signal, a first counter 533 for counting the counting signal, a first register 534 for storing the second signal outputted from the data comparator 531, and a signal generator 535 for generating an operation control signal CTRL based on the signal stored in the first register 534 and the count value of the first counter 533.

FIG. 2 shows only a part of the timing controller 5 for generating the operation control signal while the timing controller 5 according to an embodiment of the present invention includes another parts for processing and generating various control signals for driving an LCD, for processing inputted image data, and so forth as well as the elements described above. However, detailed descriptions of another parts are omitted because those are already known in the art.

Now, an operation of the timing controller 5 according to an embodiment of the present invention for generating an operation control signal is described.

For an 8-bit color XGA (Extended Graphics Array) as an example, horizontal resolution is 1024, and 1 byte is 8 bits. Therefore, each line memory 51 or 52 includes 3 (R, G, B) pages of 1024 byte memory in which 1 byte is 8 bits.

Image data are inputted serially from an external graphic controller (not shown) and stored in the first line memory 51. The data comparator 531 compares each 8 bits of the nth image data stored in the first line memory 51 and the (n−1)th image data stored in the second line memory 52 and outputs the first signal as “0” if all 8 bits of the two image data are equal to each other or as “1” if all 8 bits of the two image data are different from each other. The data comparator 531 outputs the second signal as “0” in the above two cases or as “1” if only a part of 8 bits of the two image data are equal to or different from each other.

The first signal outputted from the data comparator 531 is inputted to the AND operator 532 and logically multiplied by the pixel clock signal PC, and the result is inputted to the first counter 533. Therefore, the counting operation is performed whenever the comparison result of the two image data for each pixel is outputted.

After performing the comparison process for 1H period (1 line period), the counting value for the first counter 533 is determined to have “0”, the number of pixels based on the horizontal resolution, for example, “1024”, or a number between “0” and “1024” That is, if the entire image data corresponding to the previous line ((n−1)th image data) and those corresponding to the present line (nth image data) are equal to each other, then the counting value is “0”, or if the entire image data corresponding to the previous line ((n−1)th image data) and those corresponding to the present line (nth image data) are complementary to each other, then the counting value is “1024”. Otherwise, the counting value falls between “0” and “1024”.

Therefore, there can be four (4) cases as listed on Table 2 based on the counting value of the first counter 533 and the value of the first register 534.

TABLE 2

| | First | First | |
|---|---|---|---|
| Case | counter | register | Description |
| 1 | 0 | 0 | All image data of the nth and the (n − 1)th |
| | | | lines are equal |
| 2 | 1024 | 0 | All image data of the nth and the (n − 1)th |
| | | | lines are complementary |
| 3 | 0 < x < 1024 | 1 | At least 1 byte of the nth and the (n − 1)th |
| | | | lines are not equal or complementary |
| 4 | Don't care | 1 | At least 1 byte of the nth and the (n − 1)th |
| | | | lines are not equal or complementary |

The timing controller generates the operation control signal having an operational mode among those listed in Table 1 based on the values of the first counter 533 and the first register 534 having respective values among those listed in Table 2. For the cases 1 and 2 of Table 2, the timing controller 5 holds the data output as high impedance status or as the existing value of “0” or “1” instead of providing the image data inputted from outside to the data driver 3 to reduce power consumption and EMI generation due to signal transition.

The data driver 3 holds the image data stored in the shift register in advance ((n−1)th image data) and provides them to the liquid crystal panel assembly 1, or inverts the (n−1)th image data and provides the inverted image data to the liquid crystal panel assembly 1, or updates the image data of the shift register with the image data outputted from the timing controller 5 (nth image data) and provides the image data of the updated shift register to the liquid crystal panel assembly 1 depending on the operation control signal CTRL[1:0] which is generated based on the comparison process between image data of the timing controller 5.

The above described method of selectively providing image data from the timing controller 5 to the data driver 3 based on the relationship between the nth image data and the (n−1)th image data can be also applied to an LCD having a plurality of data drivers.

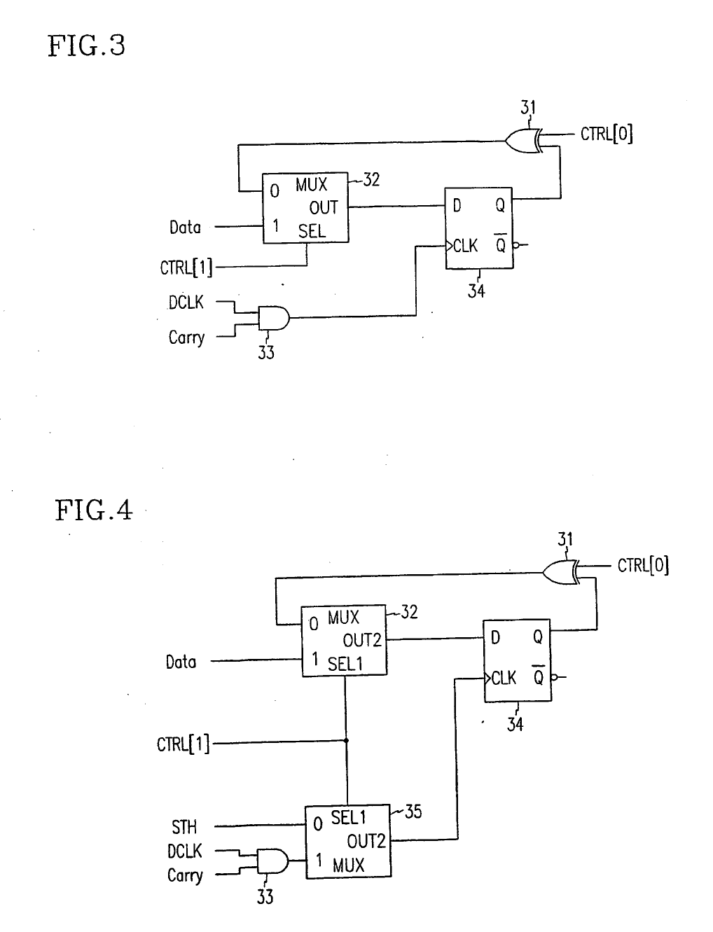

FIG. 3 is a schematic diagram of an LCD having a plurality of data drivers.

Referring to FIG. 3, a plurality of data drivers 31˜3m are arranged in a transverse direction. Operation control signals CTRL[1:0] outputted from the timing controller 5 are provided to each data driver 31˜3m, and various other control signals STH, LOAD, and DCLK are also provided to each data driver 31˜3m. Although the timing controller 5 and the data driver 3 are connected using a multi-drop structure that the timing controller provides various signals to a plurality of the data drivers via one signal line, the connecting way is not confined to this example, but applicable to a point-to-point structure that the timing controller provides various signals to a plurality of the data drivers one-to-one via respective signal lines.

In an LCD having a plurality of data drivers, each data driver performs an operation of holding, inverting, or updating image data based on the operation control signal CTRL[1:0].

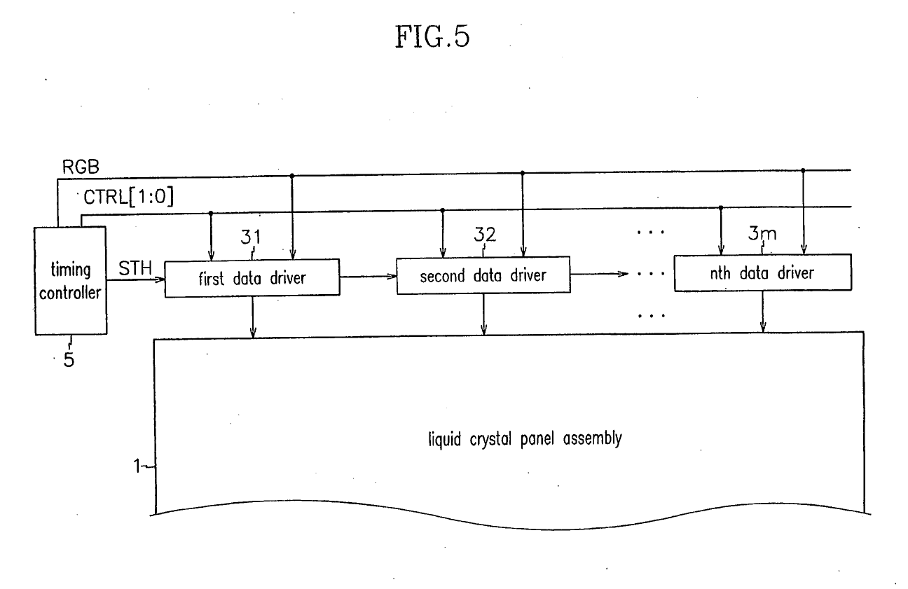

FIG. 4 is a schematic diagram of a first example of a data driver for processing operation control signals. FIG. 4 shows only a part for processing the operation control signals while another parts for providing image data to the liquid crystal panel assembly, for example, a shift register, etc. is not shown because those are already known in the art.

Referring to FIG. 4, the data driver 3 according to the first example of the present invention includes an exclusive logical sum (XOR) operator 31 for performing an exclusive logical sum operation based on a first bit CTRL[0] of the operation control signal, a first multiplexer 32 for selecting one from a first input (a signal provided from the XOR operator) and a second input (image data provided from the timing controller) based on a second bit CTRL[1] and outputting the selected input, a D flip-flop 34 for outputting image data provided selectively from the first multiplexer 32 according to a signal applied to a clock terminal, and a logical multiplication (AND) operator 33 for performing a logical multiplication operation on a data clock signal DCLK and a Carry signal and providing the result to the clock terminal of the D flip-flop 34. An output terminal Q of the D flip-flop 34 is connected to an input terminal of the XOR operator 31.

The Carry signal is an enable signal provided to a shift register of a data driver of a conventional LCD. The data clock signal DCLK is a signal applied as a rule regardless of the relationship between data such as those are equal or complementary to each other, for example, it always maintains “H” status.

Referring to FIG. 4, if the timing controller 5 provides an operation control signal CTRL[1:0] having a value “00” based on the fact that all bits of the nth and the (n−1)th image data are equal to each other, the XOR operator 31 outputs “1” based on “0” of the first bit CTRL[0] of the operation control signal and “0” of the initial output signal of the D flip-flop 34.

The signal outputted from the XOR operator 31 and the image data provided from the timing controller 5 are inputted to a first input terminal 0 and a second input terminal 1 of the first multiplexer 32, respectively, and the first multiplexer 32 selects the signal inputted from the first input terminal 0 to the D flip-flop 34 because the second bit CTRL[1] of the operation control signal received via a select terminal SEL is “0”.

Therefore, if the AND operator 33 outputs “H” signal when a shift register of corresponding data driver 3 becomes enabled according that both the data clock signal DCLK and the Carry signal are “H” levels, the D flip-flop 34 outputs the output signal “1” of the XOR operator 31 provided via an input terminal D.

The signal of “1” outputted from the D flip-flop 34 is inputted to the XOR operator 31 again, and an inverted output terminal /Q of the D flip-flop 34 outputs a signal of “0”. Therefore, a shift register (not shown) or the like of the data driver 3 holds the stored image data ((n−1)th image data) and provides them to the liquid crystal panel assembly 1 based on the signal “0” when a LOAD signal is applied.

On the other hand, if the timing controller 5 provides an operation control signal CTRL[1:0] having a value “01” based on the fact that all bits of the nth and the (n−1)th image data are complementary to each other, the XOR operator 31 outputs “0”, and the first multiplexer 32 selects the output signal of the XOR operator 31 inputted via the first input terminal 0, i.e., “0” according to “0” of the second bit CTRL[1] of the operation control signal received via the select terminal SEL and outputs it to the D flipflop 34. Therefore, a signal of “1” is outputted via the inverted output terminal /Q of the D flip-flop 34, and the shift register (not shown) or the like inverts the stored image data ((n−1)th image data) and provides them to the liquid crystal panel assembly 1.

On the other hand, if the operation control signal CTRL[1:0] having a value of “1x” is provided from the timing controller based on the fact that at least one bit of the nth image data and at least one corresponding bit of the (n−1)th image data are not equal or complementary to each other, the first multiplexer 32 selects the image data inputted via the second input terminal 0 (nth image data provided from the timing controller) according to “1” of the second bit CTRL[1] of the operation control signal inputted via the select terminal SEL and outputs it to the D flip-flop 34. Therefore, the nth image data are outputted via the inverted output terminal /Q of the D flip-flop 34, and the shift register (not shown) or the like stores the applied nth image data and provides them to the liquid crystal panel assembly 1 when a LOAD signal is applied.

According to the first example, the data clock signal DCLK must be provided continuously, and the LCD can be operated with two operational modes as follows.

For a first operational mode, the timing controller compares image data in terms of a data driver and generates an operation control signal for each data driver when it compares the nth and the (n−1)th image data. Therefore, one operation among holding, inverting, and updating is performed individually for each data driver. The operation control signal CTRL[1:0] experiences the maximum status changes of the number of the data drivers during each 1H period.

For a second operational mode, the timing controller compares image data in terms of a pixel and generates an operation control signal for each pixel when it compares the nth and the (n−1)th image data. Therefore, the data driver performs one operation among holding, inverting, and updating individually for each pixel. The operation control signal CTRL[1:0] experiences the maximum status changes of the number of horizontal resolution during each 1H period.

On the other hand, although the data clock signal DCLK must be applied constantly for the data driver driven as the first example, if it is desired to remove the data clock signal DCLK for the cases 1 and 2, i.e. for the cases that all bits of the nth image data and the (n−1)th image data are equal or complementary to each other, an STH signal (start horizontal signal for correctly latching RGB image data provided from an external graphic controller to the data driver) generated from the timing controller 5 or a signal outputted from the AND operator 33 may be selectively provided to the clock terminal of the D flip-flop 34 based on the second bit CTRL[1] of the operation control signal.

FIG. 5 is a schematic diagram of a second example of a data driver according to the present invention. The data driver according to the second example has the same structure as the first example shown in FIG. 4 except an additional second multiplexer 35 for selectively outputting one from the signal outputted from the AND operator 33 and the STH signal based on the second bit CTRL[1] of the operation control signal inputted to the select terminal SEL and providing it to the D flip-flop 34.

The data driver acts in the same way as described above except that the D flip-flop 34 outputs a signal of “0” or “1” based on the STH signal when all bits of the nth and the (n−1)th image data are equal or complementary to each other to make the (n−1)th image data be outputted as they were or as inverted. The data clock signal DCLK is maintained as DC status.

According to the second example, the timing controller dumps the information in the first line memory 51 to the second line memory in a period of 1H, an output operation of an operation control signal and data clock signal as listed in Table 3 is performed based on Table 1 in which the values stored in the first counter 533 and the first register 534 are listed based on the comparison results of the data comparator 531.

TABLE 3

| | | Operational | |
|---|---|---|---|
| Case | CTRL[1:0] | mode | Data and DCLK output |
| 1 | 00 | Hold | Data: DC (including high impedance) |
| | | | DCLK: DC (including high |
| | | | impedance) |
| 2 | 01 | Invert | Data: DC (including high impedance) |
| | | | DCLK: DC (including high |
| | | | impedance) |
| 3 | 1x | Update | Data: output nth image data |
| | | | Transmit DCLK |
| 4 | 1x | Update | Data: output nth image data |
| | | | Transmit DCLK |

For his second example, it is preferable that the data comparison is performed for the entire image data of each line, therefore, the operation control signal CTRL[1:0] is updated by 1H period.

If the timing controller and the data driver of an LCD have a multi-drop structure shown in FIG. 3, both the first and the second examples may be applied.

For a point-to-point structure, the two operational modes of the first example can be more easily implemented. This embodiment of the present invention is more effective for an LCD for OA. Since the display environment of LCDs used for OA usually corresponds to the case 1 or 2 which displays regular images, the timing controller may selectively provide image data to the data driver to reduce the power consumption while it does not affect the image data display.

While the present invention has been described in detail with reference to the preferred embodiments, it is to be understood that the invention is not limited to the disclosed embodiments, but, on the contrary, is intended to cover various modifications and equivalent arrangements included within the sprit and scope of the appended claims. For example, the selective image data transmission according to the above-described embodiments may be performed in a COG (chip on glass) type LCD in which the driver is mounted directly on a TFT array panel and the data driver is connected to a printed circuit board via a transmission film. The image data transmission according to the above embodiments may be adapted to a structure that the data driver is mounted on a FPC (flexible printed circuit) arranged between a printed circuit board and a TFT array panel.

In addition, the image data transmission methods of the above embodiments can be adapted to an LCD which transmits image data using LVDS (low voltage differential signaling) or RSDS (reduced swing differential signaling) method.

Since the application to other examples can be easily performed by the person skilled in the art, detailed description is omitted.

As shown in the above, since image data transmission between the timing controller and the data driver can be minted according to the embodiments of the present invention, power consumption and EMI due to image data switching can be reduced.

What is claimed is:

1. A liquid crystal display comprising:
a liquid crystal panel assembly including a plurality of gate lines, a plurality of data lines which are insulated from and intersects the gate lines, and a plurality of pixels each of which is formed in an area defined by of the data line and the gate line and has a switching element connected to the gate line and the data line;
a gate driver for supplying gate voltages to the gate lines;
at least one data driver for supplying data voltages corresponding to image data to the data lines; and
a timing controller for comparing nth image data applied from outside and (n−1)th image data stored therein and selectively providing the nth image data to the data driver depending on the comparison result.

2. The liquid crystal display of claim 1, wherein the timing controller generates an operation control signal based on the comparison result and provides the operation control signal to the data driver and the data driver is operated with a mode, based on the operation control signal, selected from a holding mode which provides data voltages corresponding to the stored (n−1)th image data, an inverting mode which provides data voltages corresponding to the inverted (n−1)th image data, and an updating mode which provides data voltages corresponding to the nth image data provided from the timing controller.

3. The liquid crystal display of claim 2, wherein
the timing controller includes:
a first line memory for storing the nth image data applied from outside;
a second line memory in which the (n−1)th image data applied in advance are stored; and
a control signal generator for generating an operation control signal after comparing the nth image data and the (n−1)th image data; and
the control signal generator generates:
an operation control signal of a first status to let the data driver operate with the holding mode when all bits of the nth image data and the (n−1)th image data are equal to each other;
an operation control signal of a second status to let the data driver operate with the inverting mode when all bits of the nth image data and the (n−1)th image data are complementary to each other; and
an operation control signal of a third status to let the data driver operate with the updating mode when at least one bit of the nth image data and at least one corresponding bit of the (n−1)th image data are not equal or complementary to each other.

4. The liquid crystal display of claim 1, wherein the timing controller does not provide the nth image data to the data driver when all bits of the nth image data and the (n−1)th image data are equal or complementary to each other.

5. The liquid crystal display of claim 3, wherein the timing controller generates an operation control signal whose status changes by 1H period by comparing the nth image data and the (n−1)th image data during 1H period and the data driver holds, inverts, or updates the image data by 1H period.

6. The liquid crystal display of claim 3, wherein the timing controller generates an operation control signal whose status changes as many times as the number of the data drivers by 1H period by comparing the nth image data and the (n−1)th image data for each data driver during 1H period and the data driver holds, inverts, or updates the image data for each data driver.

7. The liquid crystal display of claim 3, wherein the timing controller generates an operation control signal whose status changes as many times as the number of pixels of the line by 1H period by comparing the nth image data and the (n−1)th image data for each pixel during 1H period and the data driver holds, inverts, or updates the image data for each pixel.

8. The liquid crystal display of claim 2, wherein the operation control signal is a 2-bit signal, and the data driver includes:
an exclusive logical sum operator for performing an exclusive logical sum operation based on a first bit of the operation control signal;
a first multiplexer for selecting one, based on a second bit of the operation control signal, from a first input which is a signal provided from the exclusive logical sum operator and a second input which is image data provided from the timing controller and outputting the selected signal;
a D flip-flop for outputting image data selectively provided from the first multiplexer according to a signal applied to a clock terminal; and
a logical multiplication operator for a logical multiplication operation of the applied data clock signal and a Carry signal and providing a result of the operation to the clock terminal of the D flip-flop.

9. The liquid crystal display of claim 8, wherein the data clock signal is applied when at least one bit of the nth image data and at least one corresponding bit of the (n−1)th image data are not equal or complementary to each other.

10. The liquid crystal display of claim 1, wherein the liquid crystal display has a COG (chip on glass) structure.

11. The liquid crystal display of claim 11, wherein the image data is transmitted to the data driver by RSDS (reduced swing differential signaling).

12. A driving method of a liquid crystal display, which includes a plurality of gate lines, a plurality of data lines which are insulated from and intersects the gate lines, and a plurality of pixels each of which is formed in an area defined by the data line and the gate line and has a switching element connected to the gate line and the data line, the method comprising:
providing data voltages according to image data to the data line; and
making the data voltage be applied to the pixel by providing a gate voltage to the gate line,
wherein the provision includes:
comparing (n−1)th image data provided in advance and nth image data being provided currently;
providing data voltages corresponding to the (n−1)th image data to the data line when all bits of the nth image data and the (n−1)th image data are equal to each other;
inverting the (n−1)th image data and providing data voltages corresponding thereto when all bits of the nth image data and the (n−1)th image data are complementary to each other; and
providing data voltages corresponding to the nth image data to the data line when at least one bit of the nth image data and at least one corresponding bit of the (n−1)th image data are not equal or complementary to each other.

13. The method of claim 12, wherein the provision compares the nth image data and the (n−1)th image data during 1H period.

14. The method of claim 12, wherein the provision compares the nth image data and the (n−1)th image data for each data driver of the liquid crystal display during 1H period.

15. The method of claim 12, wherein the provision compares the nth image data and the (n−1)th image data for each pixel during 1H period.
